(19) United States
(12) Patent Application Publication
(10) Pub. No.: US 2024/0101401 A1
(43) Pub. Date: Mar. 28, 2024

(54) LIFTING AND LOWERING CONTROL SYSTEM

(71) Applicant: LIFEBRITE INTERNATIONAL CORP., Taichung City (TW)

(72) Inventor: CHAO-HSUAN LIN, Taichung City (TW)

(21) Appl. No.: 18/078,132

(22) Filed: Dec. 9, 2022

(30) Foreign Application Priority Data
Sep. 22, 2022 (TW) 111135964

(51) Int. Cl. B66F 9/07

(52) U.S. Cl. CPC B66F 9/072

(57) ABSTRACT

A lifting and lowering control system, which drives a carrier device of a stacker to perform lifting and lowering operations, includes a driving module, a position sensor, and a processor. The driving module is connected with the carrier device for driving the carrier device to move from the initial position to the lifting position, which is defined as a first travel, and to move from the lifting position to the placing position, which is defined as a second travel. The position sensor detects a first or a second displacement amount respectively generated by the first or the second travel. The processor receives and stores the first and the second displacement amounts. The processer is allowed to read the stored first or second displacement amount and accordingly control the driving module to trigger the carrier device to carry out the first or the second travel at non-constant speeds.

### BACKGROUND OF THE INVENTION

### 1. Field of the Invention

The present invention relates to lifting and lowering carrier fields, and more particularly, to a lifting and lowering control system of stackers.

### 2. Description of the Related Art

Stackers are applied in the market for operators to carry out, for example, loading and unloading operations of goods in factories, or transferring goods to and from other work lines, etc.

Although stackers save a large amount of manpower for transporting operations, operators are still needed to operate the stackers. Therefore, the need of manpower operations is not truly eliminated.

Also, conventional stackers use a servo motor as the power source to drive the transmission unit, whereby the two forks or the holding section on the front side of the stacker are lifted and lowered to carry the goods.

However, although servo motor is effective in positioning and speed controlling operations, the acquisition cost of servo motors is relatively high, which makes it impossible for the industry to effectively reduce the development and production cost of stackers.

### SUMMARY OF THE INVENTION

To improve the issues above, the present invention discloses a lifting and lowering control system, which is capable of recording the heights and positions of lifting and lowering operations, such that the carrier device is allowed to carry out an automatic transporting operation according to the recorded displacement amount, thereby saving the manpower operation and lowering the transporting time requirement. Also, by using a power source which is not a servo motor as the driving mechanism, the development and production costs are effectively reduced.

For achieving the aforementioned objectives, the present invention provides a lifting and lowering control system disposed on a stacker for driving a carrier device of the stacker to process lifting and lowering operations among an initial position, a lifting position, and a placing position, the carrier device being configured to hold an object; the lifting and lowering control system comprising:
a driving module connected with the carrier device, the driving module comprising a power source, a power transmission member, a unidirectional member, a first transmission gear and a second transmission gear engaged with the power transmission member, the power transmission member being connected between the power source and the carrier device, the unidirectional member being disposed on a power outputting part of the power source, the first transmission gear being connected with the unidirectional member and mounted around the power outputting part, the power source triggering the unidirectional member through the power outputting part along a first rotating direction to drive the first transmission gear; the second transmission gear being rotatably disposed on one side of the stacker away from the first transmission gear, the unidirectional member being a unidirectional bearing; when the power resource drives the first transmission gear, the first transmission gear drives the power transmission member to make the carrier device rise; when the power outputting part of the power source rotates along a second rotating direction in opposite to the first rotating direction, the power outputting part generates a unidirectional output with respect to the first transmission gear, so that the carrier device moves lower according to the weight of itself, wherein a displacement of the carrier device from the initial position to the lifting position driven by the driving module is defined as a first travel, and a displacement of the carrier device from the lifting position to the placing position driven by the driving module is defined as a second travel;
a position sensor connected with the power transmission member of the driving module, the position sensor being disposed in adjacent to the second transmission gear, the position sensor being configured to detect a first displacement amount and a second displacement amount of the respective first travel and the second travel of the carrier device driven by the power transmission member, wherein the position sensor is an encoder; and
a processor coupled with the driving module and the position sensor, the processor comprising a memory unit and a controlling unit, the memory unit being configured to receive and store the first displacement amount and the second displacement amount, the controlling unit being configured to read the first displacement amount and the second displacement amount stored in the memory unit, and to control the carrier device to carry out the first travel and the second travel according to the first displacement amount and the second displacement amount.

With such configuration, the heights and positions of the lifting and lowering operation of the present invention are allowed to be recorded, such that the carrier device carries out an automatic transporting operation according to the recorded displacement amounts. Therefore, the present invention effectively improves the incapability of carrying out an automatic transporting operation of conventional stackers, thereby effectively saving the manpower operation and reducing the transporting time requirement.

Also, the driving mechanism of the present invention is a power source which is not a servo motor. Therefore, the present invention effectively improves the high development and production costs of the conventional stacker using a servo motor, thereby reducing the overall development and production costs.

### BRIEF DESCRIPTION OF THE DRAWINGS

FIG. 1 is a structure block view of the system in accordance with an embodiment of the present invention.

FIG. 2 is a perspective view of the present invention disposed on a stacker.

FIG. 3 is a perspective view of the present invention disposed on the stacker taken from another point of view.

FIG. 4 is a side view of the present invention disposed on the stacker.

FIG. 5 is a partially enlarged schematic view of part A in FIG. 4.

FIG. 6 is a partially enlarged schematic view of part B in FIG. 4.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

The directional terms of, for example, “up”, “down”, “front”, “rear”, “left”, “right”, “inner”, “outer”, and “side” are only used herein for illustrating the relative directions shown in the drawings. Therefore, the directional terms are applied for the purpose of illustration and understanding of the present invention, instead of limiting the present invention.

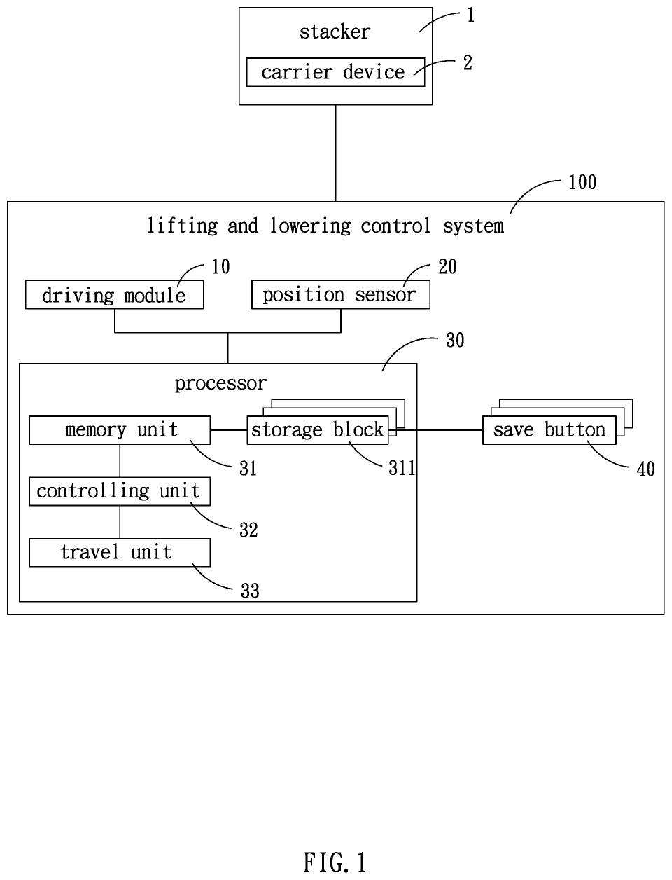

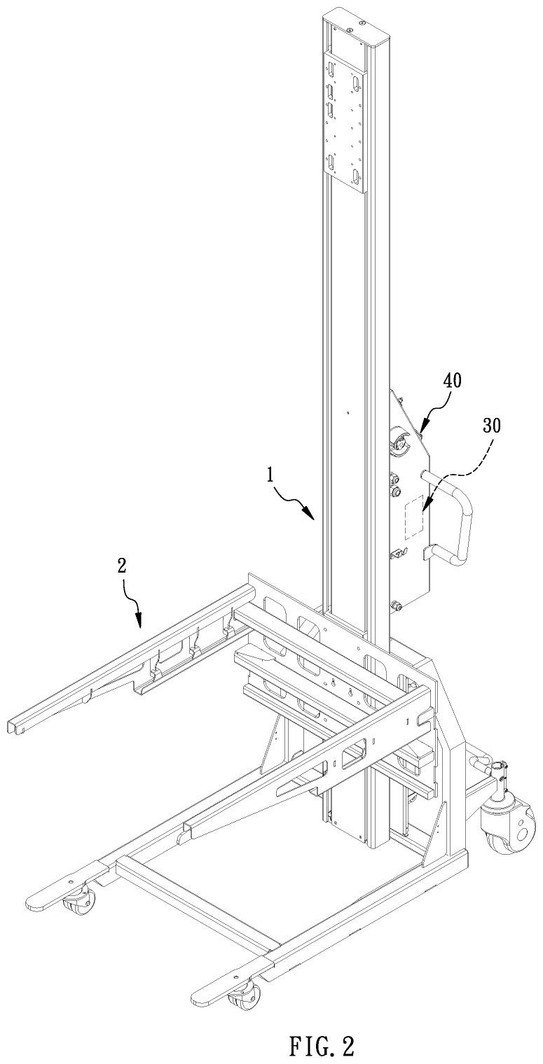

Referring to FIG. 1 to FIG. 6, the present invention provides a lifting and lowering control system 100 disposed on a stacker 1 for driving a carrier device 2 of the stacker 1 to hold an object among an initial position, a lifting position, and a placing position. Therein, when the objects held by the carrier device 2 are different, the lifting position and the placing position for the different objects are allowed to be partially identical, completely identical, or completely different from each other. In the embodiment, the initial position is the position of the carrier device 2 without holding an object, wherein the initial position is closer to the ground surface compared with the lifting position. The placing position is the position of the carrier device 2 placing the held object in a placing area. Normally, the lifting position is higher than the placing position; however, the present invention does not specifically limit the respective positional relationships among the initial position, the lifting position, and the placing position.

The lifting and lowering control system 100 comprises a driving module 10, a position sensor 20, and a processor 30.

The driving module 10 is connected with the carrier device 2 for driving the carrier device 20 to move. The displacement of the carrier device 2 from the initial position to the lifting position driven by the driving module 10 is defined as a first travel, and a displacement of the carrier device 20 from the lifting position to the placing position driven by the driving module 10 is defined as a second travel. Therein, when the carrier device 2 holds different objects, the first travel and the second travel for the different objects are allowed to be partially identical, completely identical, or completely different from each other.

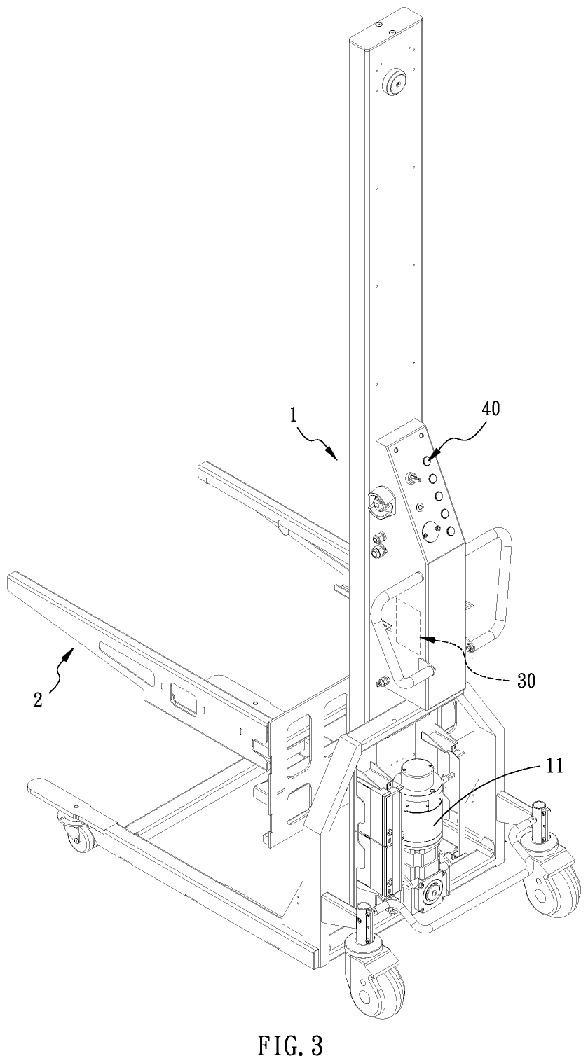

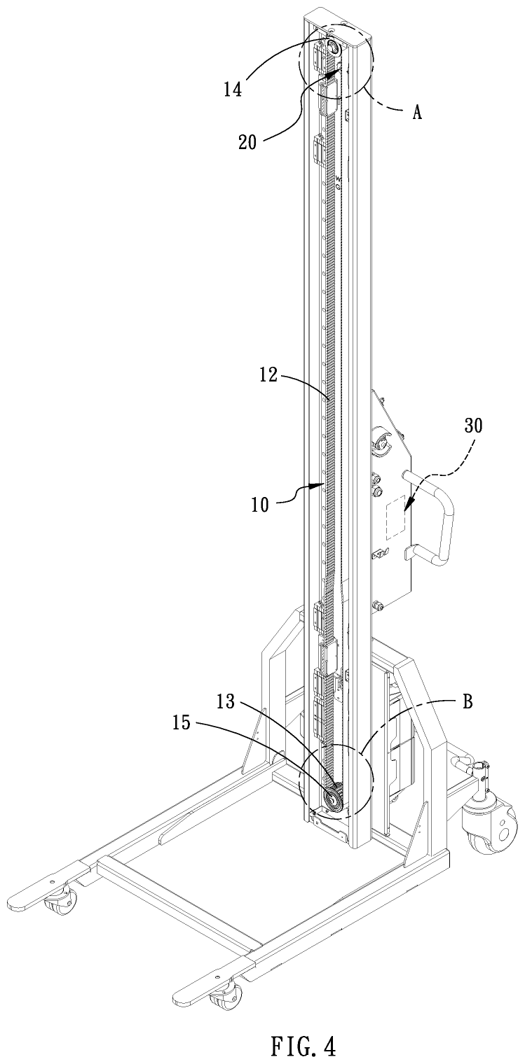

The driving module 10 comprises a power source 11, a power transmission member 12, a first transmission gear 13, a second transmission gear 14, and a unidirectional member 15. The power transmission member 12 is connected between the power source 11 and the carrier device 2. Therein, the power transmission member 12 is a toothed belt, such that the power transmission member 12 is engaged with the first transmission gear 13 and the second transmission gear 14. The first transmission gear 13 and the unidirectional member 15 are connected and mounted to a power outputting part 111 of the power source 11. The second transmission gear 14 is rotatably disposed on one side of the stacker 1 away from the first transmission gear 13. In the embodiment, the power source 11 is a motor, and the power outputting part 111 is the output shaft of the motor. Referring to the viewpoint of FIG. 3 and FIG. 4, the power source 11, the first transmission gear 13, and the unidirectional member 15 are arranged in adjacent to the bottom of the stacker 1. The second transmission gear 14 is disposed in adjacent to the top of the stacker 1.

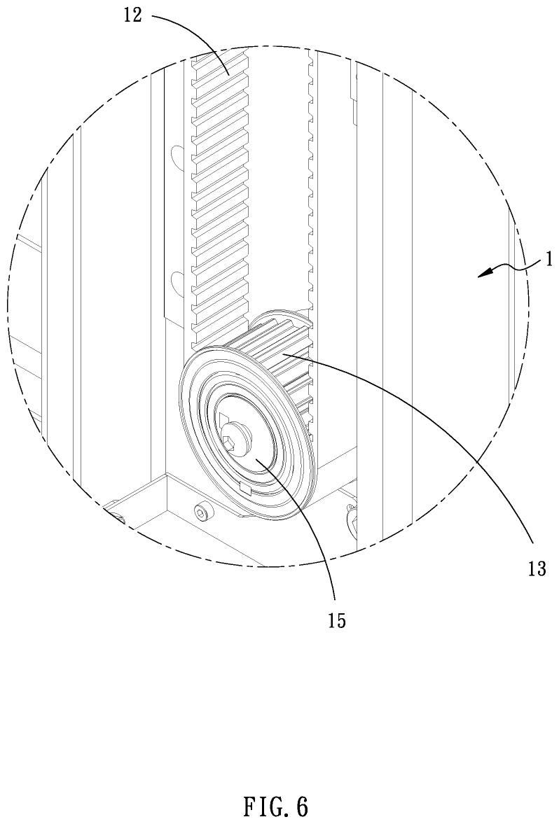

The power source 11 triggers the unidirectional member 15 through the power outputting part 111 along a first rotating direction to drive the first transmission gear 13. When the power source 11 drives the first transmission gear 13, the first transmission gear 13 drives the power transmission member 12 to make the carrier device 2 rise. When the power outputting part 111 of the power source 11 rotates along a second rotating direction in opposite to the first rotating direction, the power outputting part 111 generates a unidirectional output (idles) with respect to the first transmission gear 13, such that the carrier device 20 moves lower with respect to the stacker 1 under the effect of the weight of itself. In the embodiment, the unidirectional member 15 is a unidirectional bearing, as shown by FIG. 6.

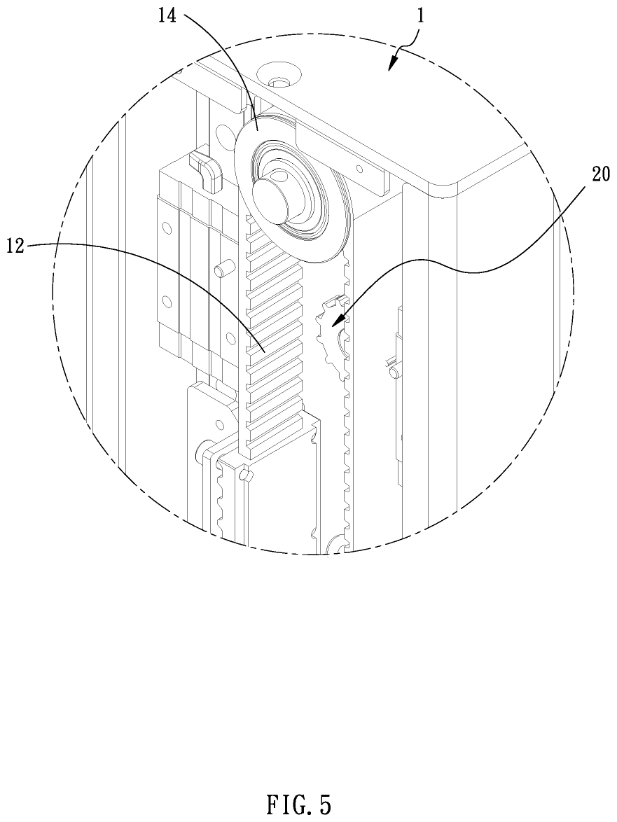

The position sensor 20 is connected with the power transmission member 12 of the driving module 10 and arranged in adjacent to the second transmission gear 14. The position sensor 20 is configured to detect the first displacement amount or the second displacement amount respectively generated by the first travel or the second travel carried out by the carrier device 2 which is driven by the power transmission member 12, as shown by FIG. 5.

The processor 30 is coupled with the driving module 10 and the position sensor 20. The processor 30 comprises a memory unit 31 and a controlling unit 32. The memory unit 31 receives and stores the first displacement amount or the second displacement amount transmitted by the position sensor 20. The controlling unit 32 reads the first or the second displacement amount stored by the memory unit 31 and controls the carrier device 2 to carry out the first or the second travel according to the read first or second displacement amount. Notably, when the carrier device 20 holds a different object for the first time, the first or second displacement amount have to be stored in the memory unit 31, such that the controlling unit 32 is allowed to read the first or second displacement amount. If the first or second displacement amount of the object to be held by the carrier device 2 is already stored in the memory unit 31, the controlling unit 32 is able to directly read the first or second displacement amount previously stored in the memory unit 31 to control the carrier device 2 to accordingly carry out the first or second travel. Therefore, there is no need to reset the transporting positions whenever each transporting operation is carried out, thereby effectively improving the automatic transporting operation.

The memory unit 31 further comprises a plurality of storage blocks 311. Each storage block 311 is configured to store the first or second displacement amount for different objects held by the carrier device 2. Therein, the memory unit 31 is coupled with a plurality of save buttons 40 corresponding to different storage blocks 311. When each save button 40 is touched, the first or second displacement amount of each object held by the carrier device 2 is stored in the corresponding storage block 311. In the embodiment, the save button 40 is configured to be pressed or touched to trigger the storing function of each storage block 311 of the memory unit 31.

The processor 30 further comprises a travel unit 33. The travel unit 33 is configured to, according to the objects held by the carrier device 2, set the sequence of the controlling unit 32 calling each save button 40 through the memory unit 31, so as to control the carrier device 2 to carry out the first or the second travel. Therefore, there is no need to reset the transporting positions whenever each transporting operation is carried out, thereby effectively improving the automatic transporting operation.

The controlling unit 32 is able to control the driving module 10 to trigger the carrier device 2 to carry out the first or the second travel at non-constant speeds. Therein, the controlling unit 32 is able to drive the driving module 10 to trigger the carrier device 2 to carry out the first or the second travel at a first or a second speed. In the embodiment, the first speed is faster than the second speed, and the running time of the first speed is longer than the running time of the second speed. The controlling unit 32 drives the driving module 10 to trigger the carrier device 2 to firstly carry out the first or the second travel at the first speed. When the carrier device 2 approaches the target lifting position of the first travel or the target placing position of the second travel, the controlling unit 32 drives the driving module 10 to trigger the carrier position 2 to move to the lifting position or the placing position at the second speed.

With the foregoing configuration, the present invention is able to record the heights and positions of the lifting and lowering operations of the lifting and lowering control system 100, such that the carrier device 2 carries out an automatic transporting operation according to the recorded displacement amount. Therefore, the present invention effectively saves the manpower operation and reduces the transporting time requirement.

Furthermore, the lifting and lowering control system 100 uses a power source which is not a servo motor, thereby effectively reducing the development and production costs.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A lifting and lowering control system disposed on a stacker for driving a carrier device of the stacker to move higher or lower among an initial position, a lifting position, and a placing position, the carrier device being configured to hold an object; the lifting and lowering control system comprising:
a driving module connected with the carrier device, the driving module comprising a power source, a power transmission member, a unidirectional member, a first transmission gear and a second transmission gear engaged with the power transmission member, the power transmission member being connected between the power source and the carrier device, the unidirectional member being disposed on a power outputting part of the power source, the first transmission gear being connected with the unidirectional member and mounted around the power outputting part, the power source triggering the unidirectional member through the power outputting part along a first rotating direction to drive the first transmission gear; the second transmission gear being rotatably disposed on one side of the stacker away from the first transmission gear, the unidirectional member being a unidirectional bearing; when the power resource drives the first transmission gear, the first transmission gear drives the power transmission member to make the carrier device rise; when the power outputting part of the power source rotates along a second rotating direction in opposite to the first rotating direction, the power outputting part generates a unidirectional output with respect to the first transmission gear, so that the carrier device moves lower by a weight of itself; wherein a displacement of the carrier device from the initial position to the lifting position driven by the driving module is defined as a first travel, and a displacement of the carrier device from the lifting position to the placing position driven by the driving module is defined as a second travel;
a position sensor connected with the power transmission member of the driving module, the position sensor being disposed in adjacent to the second transmission gear, the position sensor being configured to detect a first displacement amount and a second displacement amount of the respective first travel and the second travel of the carrier device driven by the power transmission member, wherein the position sensor is an encoder; and
a processor coupled with the driving module and the position sensor, the processor comprising a memory unit and a controlling unit, the memory unit being configured to receive and store the first displacement amount and the second displacement amount, the controlling unit being configured to read the first displacement amount and the second displacement amount stored in the memory unit, and to control the carrier device to carry out the first travel and the second travel according to the first displacement amount and the second displacement amount.

2. The lifting and lowering control system of claim 1, wherein the controlling unit controls the driving module to trigger the carrier device to carry out the first or the second travel at non-constant speeds.

3. The lifting and lowering control system of claim 2, wherein the controlling unit drives the driving module to trigger the carrier device to carry out the first travel or the second travel at a first speed or a second speed; the first speed is faster than the second speed, and a running time of the first speed is longer than a running time of the second speed.

4. The lifting and lowering control system of claim 3, wherein the controlling unit drives the driving module to trigger the carrier device to firstly carry out the first or the second travel at the first speed; when the carrier device approaches the lifting position of the first travel or the placing position of the second travel, the controlling unit drives the driving module to trigger the carrier device to move to the lifting position or the placing position at the second speed.

5. The lifting and lowering control system of claim 1, wherein the memory unit comprises a plurality of storage blocks; each storage block is configured to store the first or the second displacement amount corresponding to different objects held by the carrier device.

6. The lifting and lowering control system of claim 5, wherein the memory unit is coupled with a plurality of save buttons corresponding to different storage blocks; when each save button is touched, the first or the second displacement amount of each object held by the carrier device is stored in the corresponding storage block.

7. The lifting and lowering control system of claim 6, wherein the processor comprises a travel unit; the travel unit is configured to, according to different objects held by the carrier device, set a sequence of the controlling unit calling each save button through the memory unit.

8. The lifting and lowering control system of claim 1, wherein the power transmission member is a toothed belt.

9. The lifting and lowering control system of claim 1, wherein the initial position is the position of the carrier device without holding an object, wherein the initial position is closer to the ground surface compared with the lifting position; the placing position is the position of the carrier device placing the held object in a placing area, wherein the lifting position is higher than the placing position.
